(19) United States
(12) Patent Application Publication
(10) Pub. No.: US 2018/0231195 A1
(43) Pub. Date: Aug. 16, 2018

(54) PORTABLE LIGHTING SYSTEM

(71) Applicant: Robyn Reid Hoffman, Mesa, AZ (US)

(72) Inventor: Robyn Reid Hoffman, Mesa, AZ (US)

(21) Appl. No.: 15/955,187

(22) Filed: Apr. 17, 2018

Related U.S. Application Data
(63) Continuation-in-part of application No. 15/160,750, filed on May 20, 2016, now abandoned.

(51) Int. Cl. F21L 4/08; F21V 15/01; F21V 23/00; F21V 23/04; F21V 21/06; F21V 21/22; F21V 31/00; F21L 4/04; F21V 21/14

(52) U.S. Cl. CPC F21L 4/08; F21V 15/01; F21V 23/003; F21V 23/0471; F21V 21/06; F21Y 2115/10; F21V 31/00; F21V 23/0435; F21L 4/04; F21V 21/145; F21V 21/22

(57) ABSTRACT

A portable lighting system is disclosed that provides illumination at remote locations without need of an external power source. The portable lighting system is easily transported by disassembling removably attachable components, a head unit, an adjustable support structure at least four feet in height, and a base unit. When assembled, the portable lighting system provides level above ground illumination by LED light at a height of at least four feet and extendable up to sixteen feet, controlled by switch, remote control, or motion detection, with variable intensity and wavelength controls.

### CROSS REFERENCE TO RELATED APPLICATION

The present application is a Continuation-In-Part of U.S. Non-Provisional application Ser. No. 15/160,750 filed May 20, 2016, which is related to and claims the benefit under 35 U.S.C. § 119(e) of the prior U.S. provisional application Ser. No. 62/164,094 filed May 20, 2015 entitled “Recreational Mobile Outdoor Light”, the contents of which are incorporated herein by this reference in their entirety, and are not admitted to be prior art with respect to the present invention by the mention in this cross-reference section.

### FIELD OF THE INVENTION

The present invention relates generally to an apparatus for providing lighting. More specifically, the present invention relates to providing a portable lighting system designed to provide illumination at a height greater than 4 feet without the need for a generator or other separate power source.

### BACKGROUND OF THE INVENTION

When humans are outdoors for recreational or work activities in the dark away from the AC power supplies such as typical home and business 120V AC power, devices such as lanterns, campfires, and torches are used to provide lighting. Especially in camping situations, no portable lighting system exists that floods an area with light where the light source is situated above the heads of the users to draw away bothersome insects such as mosquitos and flies among others. Additionally, no portable lighting system is available for hunting or camping situations that rely on a motion sensor to detect animal movement to activate the light to scare off the animal intruders. Typically, such devices are not advanced enough and lack innovation compared to the present invention.

### OBJECTS AND FEATURES OF THE INVENTION

It is primary object and feature of the present invention to provide a portable lighting system. It is further a primary object and feature of the present invention to provide a portable light system comprising.

It is another object and feature of the present invention to provide a primary light source and a power storage unit. It is another object and feature of the present invention to provide a LED as said primarily light source. It is another object and feature of the present invention to provide at least one battery as said power storage unit.

It is another object and feature of the present invention to provide a head unit to contain said at least one LED to provide illumination and said at least one lithium battery to power said LED. It is another object and feature of the present invention to that the head unit comprise a weatherproof enclosure which contains said at least one LED and said at least one lithium battery, which protects the head unit's contents from the environment.

It is another object and feature of the present invention that said head unit incorporates a switch to turn the LED on and off. It is another object and feature of the present invention to provide a luminous intensity control for adjusting the luminosity provided by said LED located within said head unit. It is another object and feature of the present invention to provide a motion detector for turning said LED on when motion is detected, and off when no motion is detected.

It is another object and feature of the present invention to provide a support structure and a base unit configured and arranged so that said head unit be positioned and a user determined height above the ground. It is yet another object and feature of the present invention that said base unit configured and arranged on the end of the support structure opposite the head unit, and said base unit includes a spike configured and arranged to penetrate the ground in such a way to secure the support structure in a vertical orientation from the ground. It is yet another object and feature of the present invention that said support structure includes an adjustment member configured and arranged to allow adjustment of the height of the head unit from the ground. It is yet another object and feature of the present invention that said adjustment member use a twist lock mechanism.

It is another object and feature of the present invention to provide a light directionality adjustment member to allow user desired orientation of said head unit such that illumination be directed towards a user desired location.

It is another object and feature of the present invention to provide a detachable coupling member between said head unit and said support structure. It is another object and feature of the present invention to provide a detachable coupling member between said support structure and said base unit.

It is another object and feature of the present invention that said power storage unit may be recharged using a solar panel. It is another object and feature of the present invention that said power storage unit may be recharged using an adaptor to plug into the cigarette lighter of a vehicle. It is another object and feature of the present invention that said power storage unit may be recharged by using an AC to DC converter.

It is another object and feature of the present invention to provide a secondary light source to provide illumination directed towards a location other than the location the primary light source is directed.

It is another object and feature of the present invention to provide a level indicator on base unit. It is another object and feature of the present invention to provide a recessed level indicator in said base unit which can be observed when securing said base unit in the ground by use of said spike on said base unit.

It is another object and feature of the present invention to provide illumination in different wavelengths of light.

It is another object and feature of the present invention to for camping. It is another object and feature of the present invention to be useful and handy for outdoor work. It is another object and feature of the present invention to be useful and handy for concerts. It is another object and feature of the present invention to be useful and handy for emergencies.

### SUMMARY OF INVENTION

The present invention solves the above problems by providing a portable lighting system comprising a head unit, further comprising a housing with a lens, at least one LED, at least one power storage unit, and at least one power switch. The present invention further comprises at least one support structure, wherein the support structure is at least four feet in height. The present invention further comprises at least one base unit wherein the at least one base unit further comprises at least one level indicator. The head unit is preferably removably attached to the support structure at a distal end such that the head unit is at least four feet in the air. The at least one base unit is preferably removably attached to the at least one support structure at a proximal end. The at least one power storage unit is preferably configured and arranged to be electrically recharged by an alternating current power source and by direct current power source.

Further, the present invention relates to providing a portable lighting system, which is portable and handy. More particularly, this invention relates to providing a portable lighting system, which provides illumination using which needs no external alternating current (AC) power source. More particularly, this invention relates to providing a portable lighting system, which uses at least one light emitting diode (LED) and a lithium battery power source in a weatherproof housing. More particularly, this invention relates to providing a portable lighting system, which provides illumination using at least one LED and battery power source in a weatherproof housing detachably arranged and configured on top of a support structure, which is arranged and configured on a base unit which includes a level indicator.

The present invention is a portable lighting system meant for recreational or work activities and can act as a camp light or a security light. Further the present invention can be used for lighting in emergency, work, fishing, camping or other outdoor activities where illumination is required while keeping the insects away from the people. Further the present invention is rechargeable by direct current (DC) power sources such as a car charger or solar panel. Further the present invention can be used in remote locations and provide illumination for any other work, medical or recreational activities where the environment would otherwise be dark.

### BRIEF DESCRIPTION OF THE DRAWINGS

FIG. 1 is a perspective view of a portable lighting system in use according to the preferred embodiment of the present invention.

FIG. 2 is a perspective view of the head unit of the portable lighting system according to the preferred embodiment of the present invention.

FIG. 3 is a top view of the head unit of the portable lighting system according to the preferred embodiment of the present invention.

FIG. 4 is a perspective view of the base unit of the portable lighting system according to the preferred embodiment of the present invention.

FIG. 5 is a top view of the base unit for the portable lighting system according to the preferred embodiment of the present invention.

FIG. 6 is a perspective view of a portable lighting system in use according to an alternate embodiment of the present invention.

FIG. 7 is a perspective view of the head unit and swivel attachment unit according to an alternate embodiment of the present invention.

### DETAILED DESCRIPTION PREFERRED EMBODIMENTS OF THE INVENTION

The following description is provided for purposes of explanation, but not limitation, of the present invention. Specific details set forth in the following embodiments provide for a thorough understanding of the present invention. However, it will be apparent to one skilled in the art that specific details described in the preferred embodiments are not limitations required to practice the present invention, and the present invention may be practiced in embodiments that depart from those described.

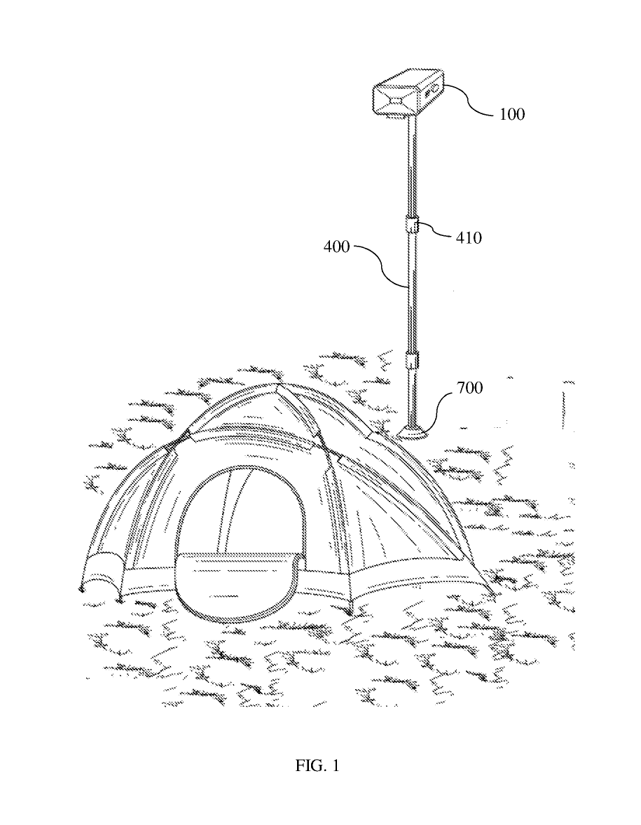

Now referring to the drawings, FIG. 1 shows a portable lighting system structured and arranged to provide at least three weatherproof components, a head unit 100, a support structure 400, and a base unit 700. The head unit 100 is configured and adapted such that it may be removably attached to a distal end of the support structure 400. The base unit 700 is configured and adapted such that it may be removably attached to a proximal end of the support structure 400 opposite from the head unit 100. The support structure 400 is adapted and configured such that its height may be adjusted from four feet up to sixteen feet.

Because the head unit 100 and base unit 700 are configured and adapted to be removably attached to the support structure 400 by a user, and because the support structure 400 may be adjustably shortened or lengthened by the user, the portable lighting system may easily be dismantled into three separate weatherproof components by the user, thereby allowing for storage and easy transportation of the portable lighting system. Also, because both the head unit 100 and base unit 700 are configured and adapted to be removably attached to the support structure 400 by the user, when needed, the portable lighting system can be easily assembled. The ability to quickly disassemble and reassemble the portable lighting system makes it useful at remote locations.

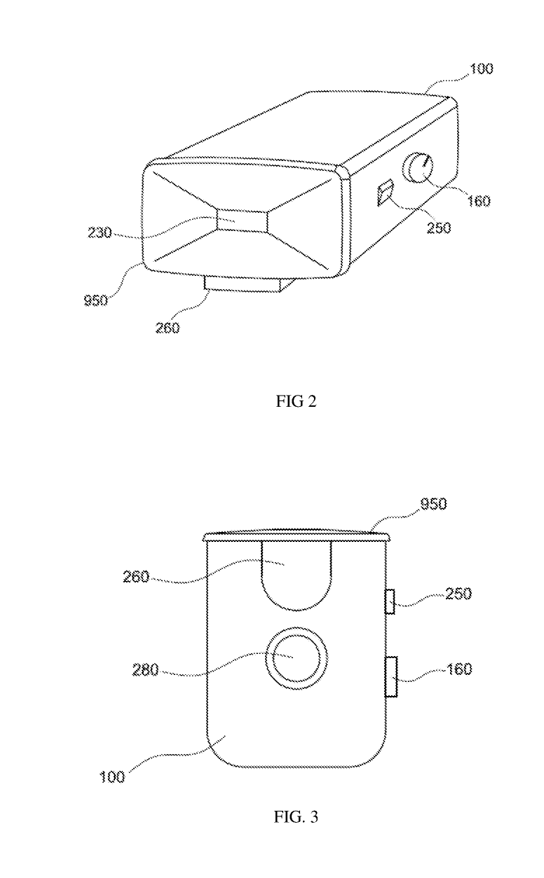

FIG. 2 shows a perspective view of the head unit, comprising a housing, at least one LED 230, at least one power storage unit, and at least one power switch. The housing preferably further comprises a lens and is preferably weatherproof. The housing preferably fully encloses the at least one power storage unit, the at least one LED, and all electrical components. The LED is preferably electrically connected to the at least one power storage unit and the at least one power switch.

FIG. 2 further illustrates the at least one LED 230 located behind the preferably clear lens 950 inside the head unit 100. In this preferred embodiment the head unit 100 is preferably a weatherproof enclosure containing both the lens and the housing. In this preferred embodiment there is preferably a motion sensor 260 preferably located under the lens 950 and structured and arranged to detect movement and power on the at least one LED. In this preferred embodiment there is preferably a switch 250 to turn the at least one LED 230 on and off preferably located on the side of the head unit 100. Further, in this preferred embodiment there is preferably a luminous intensity control 160 preferably located next to the power switch the side of the head unit 100.

In the preferred embodiment shown in FIG. 1, there is preferably a power storage unit enclosed inside of the housing of the head unit 100. Preferably the power storage unit is a battery. Preferably, the battery is configured and adapted to operate at 12V DC. Alternately preferably other DC voltages may be used. Alternately preferably other battery types may be used.

The lens 950 is preferably configured and arranged to focus illumination such that the portable lighting system provides a spotlight. Alternately preferably, the lens 950 may be configured and arranged to spread out illumination such that the portable lighting system provides a floodlight.

In this preferred embodiment, the head unit 100 has two controls, the first being the power switch 250 that can be used to turn the system on or off, and the second is the luminous intensity control 160 allowing the user to adjust the intensity of illumination provided by the at least one LED 230 when the at least one LED 230 is on. In this preferred embodiment when the system is turned on, the at least one LED 230 will preferably provide illumination whenever the motion sensor 260 detects movement of a person, thing, or animal. In this preferred embodiment, the at least one LED 230 will stay on for one (1) minute after motion is detected, and then will go off. The length of time that the at least one LED 230 stays on after being activated by the motion sensor 260 can preferably be adjusted.

Alternately preferably, the head unit 100 may have another control, which when adjusted will preferably change the wavelength of the illumination provided by the at least one LED 230. In this alternate preferred embodiment, the user may adjust the wavelength of illumination to a color more suited for a particular application. For example, changing the color of illumination may prevent disturbing wildlife or may provide higher contrast when working. In this alternative embodiment, a wireless remote control device may preferably be used to adjust color, luminesce intensity, and/or turn the portable lighting system on and off.

Alternately preferably, the switch 250 and luminous intensity control 160 may be located elsewhere on the head unit 100. Alternately preferably, the switch 250 may be a three (3) position switch, having the positions that correspond to constant on, on when motion detected, and off. Alternately preferably, another control may be positioned on the head unit 100 to allow the user to adjust the delay time between when motion is detected which turns on the at least one LED 230 and when the at least one LED 230 is turned off.

FIG. 2 is a bottom view of the preferred embodiment of the head unit 100 of the portable lighting system showing a coupling member 280. The coupling member preferably allows the head unit 100 to be detachably coupled to the support structure 400 as shown in FIG. 1. FIG. 2 further shows the preferred placement of the lens 950 on the head unit 100, the preferred placement of the motion sensor 260 on the head unit 100, the preferred placement of the switch 250 and the preferred placement of the luminous intensity control 160 located on the side of the head unit 100.

Alternately preferably, the head unit 100 may include an electrical connection located under a preferably weatherproof cover. In this alternately preferable embodiment, the electrical connector may be configured and adapted so that a 12V DC power source can be used to charge the power storage unit located within the head unit 100. In this alternately preferred embodiment, a 12V DC power source may be used to recharge the power supply unit that is preferably located within the head unit 100. In this alternately preferred embodiment, the 12V DC power source may be provided by a system which preferably includes a plug adapted to a cigarette lighter receptacle in a vehicle. Alternately preferably the 12V DC power source may be provided by using a solar panel containing preferably at least one solar cell. It is further an alternately preferred embodiment that DC voltages other than 12V be used.

Alternately preferably, a secondary light source may provide illumination, such that the at least one additional LED may be configured and arranged to provide light in a direction different than that of the first at least one LED 230.

FIG. 3 is a perspective view of the preferred embodiment of the base unit 700 of the portable lighting system. In this preferred embodiment, the base unit 700 has a socket 720 preferably structured and arranged to allow the support structure to be removably attached to the preferred embodiment of the base unit 700. Preferably positioned at the bottom of the socket 720 is a level indicator 730.

The bottom portion of the base unit 700 is preferably structured and arranged to provide a spike 710 that is preferably used to anchor the base unit 700 into the ground. The level indicator 730 preferably may be used by the user to determine if the base unit 700 has been anchored into the ground in such a way that the support structure 400 will be arranged vertically and perpendicular to level ground, where said support structure 400 is preferably removably attached to said base unit 700. Alternately preferably, the base unit 700 is preferably structured and arranged to sit on top of a ground surface. As an example, the base unit could be a tripod structure or another type of weighted base unit.

Because the ground consistency varies at different locations, it is preferably useful to have the base unit 700 removably coupled to the support structure 400. With the base unit 700 removed from the support structure 400, the base unit preferably can be driven into the ground separately without risking damage to any other components of the portable lighting system.

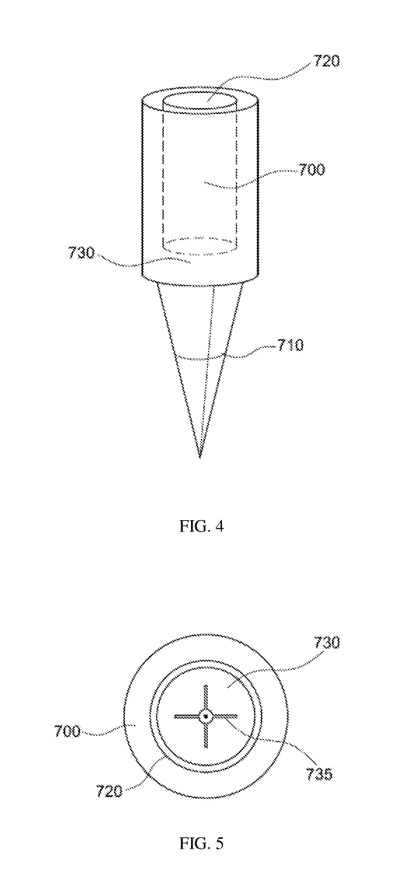

Since the ground is not always level, the user may not easily be able to tell how to best orient the base unit 700 such that the support structure 400 will be perpendicular to a level measurement when it is removably attached to the base unit 700. Therefore, it is useful and handy to preferably have a level indicator 730 when driving the base unit 700 into the ground. FIG. 4 is a top view of the preferred embodiment of the base unit 700, illustrating how a bubble level will preferably indicate if the base unit 700 is positioned in the ground such that the support structure 400 will be perpendicular to level. Preferably, when the level indicator bubble 735 is centered in the crosshairs of the level indicator 730, the user will have assurance that the base unit 700 was driven into the ground in such a way that when the support structure 400 is removably attached to the base unit 700, the support structure 400 will be perpendicular to level.

Alternately preferably, the bubble level will indicate if the base unit 700 is positioned correctly using a bulls eye target to center the bubble.

FIG. 4 is a top view of the preferred embodiment of the base unit 700 for the portable lighting system illustrating the top view of the level indicator 730 is preferably located at the bottom of the socket 720, wherein the level indicator bubble 735 is preferably at the center of the level indicator 730 and in the middle of the crosshairs.

FIG. 5 is a perspective view of the preferred embodiment of the portable lighting system illustrating how the head unit 100 is positioned atop the support structure 400. The head unit 100 is preferably removably coupled to the support structure 400 using the socket 280 preferably located at the base of the head unit 100, as shown in FIG. 2.

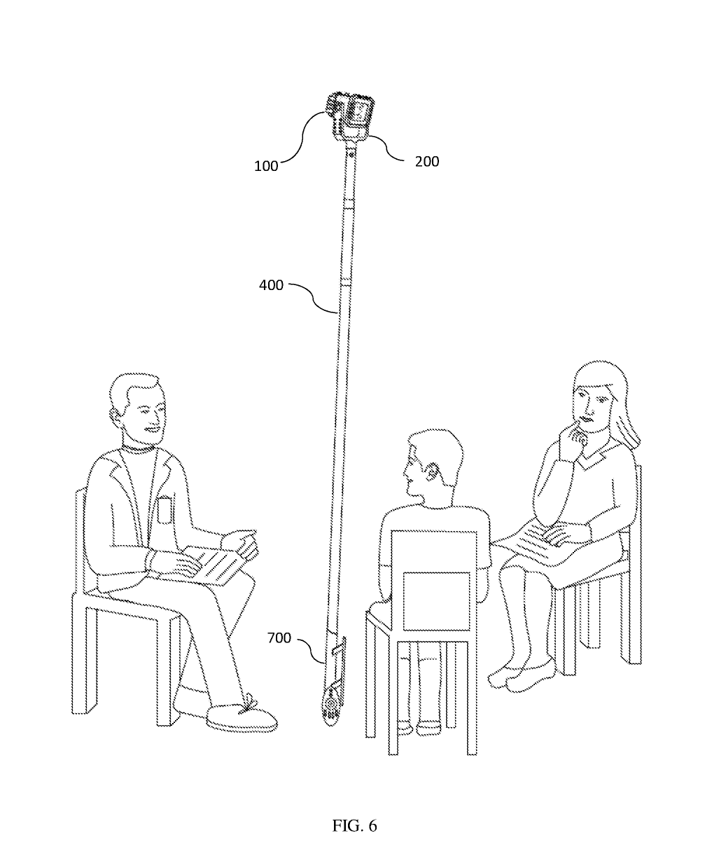

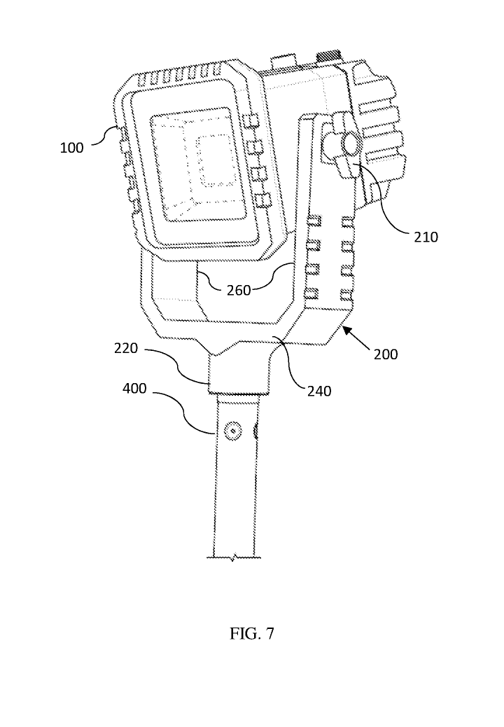

Alternately preferably, as shown in FIGS. 6 and 7, the portable lighting system may be structured and arranged such that a swivel attachment unit 200 is preferably located between the support structure 400 and the head unit 100, preferably providing the user the ability to adjust the directionality of illumination being provided from the at least one LED 230. Preferably, the swivel attachment unit 200 is U-shaped such that the head unit is removably attached to the inside of the opposing side members 260 of the U.

As further shown in FIG. 7, the swivel attachment unit 200 may preferably removably couple to opposing sides of the head unit 100 using a threaded fastener 210. When loosened, but not completely removed, the head unit can be adjusted to point the LED where the user wants. The swivel attachment unit 200 preferably further comprises a tubular socket 220 centered on the bottom cross member 240 that is sized to fit over the support structure 400. There may be a set fastener to secure the swivel attachment unit 200 to the support structure 400 that extends through the tubular socket and presses against the outside surface of the support structure.

In the preferred embodiment, the support structure is preferably adjustable from a minimum height of four feet and extendible up to a maximum height of sixteen feet. The support structure preferably further comprises a length adjustment member 410 preferably located on the support structure 400, as shown in FIG. 5. Said length adjustment member 410 may preferably be a twist lock mechanism to secure at least two telescoping poles together, wherein said twist locking mechanism and at least two telescoping poles are preferably elements of the support structure 400. The at least two or more telescoping poles are preferably rigid when said twist locking mechanism is engaged. Alternately preferably, more than two poles and more than one adjustable member may be used to provide height adjustment.

In the preferred embodiment, said support structure 400 may be configured and arranged to slide into the socket 720 of said base unit 700 as shown in FIG. 5. Alternately preferably, said support structure 400 may be threaded into said base unit 700. Alternately preferably, said support structure 400 may use a twist lock mechanism to be secured into said base unit 700.

The telescoping poles, which are components of the support structure 400, are preferably made of aluminum, and preferably the twist lock mechanism that creates the adjustment member is preferably made of plastic. The telescoping poles are alternately preferably made of plastic. The telescoping poles are alternately preferably made of carbon fiber. The twist lock mechanism is alternately preferably made of metal. The twist lock mechanism is alternately preferably made of carbon fiber.

Although preferred embodiments are disclosed herein, it is understood that the broadest scope of this invention includes variations to types of materials, shapes, sizes, and any such element that could be obviously replaced by one skilled in the art.

We claim:

1. A portable lighting system comprising;
a head unit, further comprising: a housing further comprising a lens, at least one LED, at least one power storage unit, and at least one power switch;
at least one support structure, wherein said support structure is at least four feet in height;
at least one base unit structured and arranged to hold said at least one support structure in a vertical position;
wherein said head unit is removably attached to said support structure at a distal end;
wherein said at least one base unit is removably attached to said at least one support structure at a proximal end; and
wherein said power storage unit is configured and arranged so that it may be electrically recharged by an alternating current power source and by direct current power source.

2. The portable lighting system according to claim 1, wherein said light unit further comprises a luminous intensity control.

3. The portable lighting system according to claim 1, wherein said light unit further comprises a motion detector.

4. The portable lighting system according to claim 1, wherein said head unit further comprises at least two LEDs, wherein said two LEDs are structured and arranged such that direction of illumination can be separately adjusted.

5. The portable lighting system according to claim 1, wherein said base unit is a spike designed to penetrate a ground surface.

6. The portable lighting system according to claim 1, wherein said support structure is extendable in height in a range from four feet in height to sixteen feet.

7. The portable lighting system according to claim 1, wherein said support structure is extendable in height in a range from six feet in height to twelve feet.

8. The portable lighting system according to claim 1, wherein said base unit further comprises a pocket configured and arranged to contain said at least one level indicator, and said pocket is configured and arranged to create a detachable coupling to said support structure.

9. The portable lighting system according to claim 1, wherein said head unit further comprises at least one solar cell electrically coupled to said power storage unit.

10. The portable lighting system according to claim 1, wherein said housing of said head unit is weatherproof.

11. The portable lighting system according to claim 10, wherein said housing further comprises at least one detachable coupling, wherein said at least one detachable coupling is structured and arranged to allow said housing to be detachably coupled to said support structure.

12. The portable lighting system according to claim 1, further comprising a wireless remote control device.

13. The portable lighting system according to claim 12, wherein said wireless remote control device provides functions comprising; turning the LED on, turning the LED off, setting the system to motion detection operation, changing the setting of the luminosity intensity control, and changing the wavelength of the illumination.

14. The portable lighting system according to claim 1, wherein said power storage unit is a battery.

15. A portable lighting system comprising:
a head unit, further comprising: a housing further comprising a lens, at least one LED, at least one power storage unit, and at least one power switch;
at least one support structure, wherein said support structure is at least four feet in height and extendable to sixteen feet;
a swivel attachment unit structured and arranged to removably couple said head unit to said support structure at a distal end;
at least one base unit structured and arranged to hold said at least one support structure in a vertical position;
wherein said at least one base unit is removably attached to said at least one support structure at a proximal end; and
wherein said power storage unit is configured and arranged so that it may be electrically recharged by an alternating current power source and by direct current power source.

16. The portable lighting system according to claim 1, wherein said head unit further comprises a luminous intensity control.

17. The portable lighting system according to claim 1, wherein said head unit further comprises a motion detector.

18. The portable lighting system according to claim 1, wherein said head unit further comprises at least two LEDs, wherein said two LEDs are structured and arranged such that direction of illumination can be separately adjusted.

19. The portable lighting system according to claim 1, wherein said base unit is a spike designed to penetrate a ground surface.

20. The portable lighting system according to claim 1, wherein said head unit further comprises at least one solar cell electrically coupled to said power storage unit.
